(19) United States
(12) Patent Application Publication
(10) Pub. No.: US 2007/0011655 A1
(43) Pub. Date: Jan. 11, 2007

(54) System and method for creating software modifiable without halting its execution

(76) Inventor: Pradeep Tumati, Blacksburg, VA (US)

Correspondence Address: MCNAIR LAW FIRM, P.A., P.O. BOX 10827, GREENVILLE, SC, 29603-0827, US

(21) Appl. No.: 11/520,090

(22) Filed: Sep. 13, 2006

Related U.S. Application Data
(62) Division of application No. 10/023,247, filed on Dec. 13, 2001.
(60) Provisional application No. 60/302,420, filed on Jul. 2, 2001.

(51) Int. Cl. G06F 9/44

(52) U.S. Cl. 717/122; 717/120

(57) ABSTRACT

This invention is directed to a computerized system and method for creating a computer file trademarked as a hot pack to be used to modify object code without the need to halt the executing code. The present invention provides a system called a Development Environment (DE) for a computer programmer. The DE allows for source code to be created, segmented into grains and translated into object code. The source code can then be modified to a second version, also having grains that can be mapped onto the grains of the first version to identify the grains of the first object code that needs to be modified according to the second version of object code.

### CROSS-REFERENCE TO RELATED APPLICATION

This application is a divisional of application Ser. No. 10/023,247 filed Dec. 13, 2001, which in turn claims priority on provisional application No. 60/302,420, filed Jul. 2, 2001.

### FIELD OF THE INVENTION

This invention is directed to a computerized system and method for creating a means to modify an executing computer software application without the need to halt the target application.

### BACKGROUND OF THE INVENTION

From the mid-1980's to the present, there has been an extraordinary adaptation of computers into almost all aspects of business. The unparalleled explosion of the computer software industry and the Internet has led to a high reliance on technology and, particularly, software applications. While there have been astronomical advances in computer hardware, it is the applications themselves at the core of the functionality of computers. Simply said, a computer is useless without software to run it. Nearly a decade ago e-mail was just beginning to enter into the private sector and become adopted by businesses for day-to-day communications. Today, it is hard to imagine functioning without such advances as e-mail, instant messaging, global communications, file transfers, and other electronic transmissions made possible by advances in computer technology. The side effects of this tremendous acceptance of computerized systems is that individuals and business are becoming more and more reliant upon the systems and, particularly, on the applications running them. It has now reached the point to where applications need to run uninterrupted else they deprive the users of their functionality and dramatically effect the operations of business.

Applications that must run uninterrupted exist in several areas. For example, business software that provides service for clients 24 hours a day, such as 24-hour stock trading systems, hospital equipment used to maintain patients=health, and radar and air traffic control systems used to control airline flights. Any interruptions to these systems is unacceptable. All cannot tolerate downtime.

In the case of stock trading, seconds of downtime in today's volatile stock market can cost millions of dollars. Banking software and many e-businesses need their software running continuously. A period of downtime damages both the profits and goodwill of a company.

In today's global economy, there is no time that a piece of business software can be safely offline. Although it may be 3:00 a.m. in the United States, it is 9:00 a.m. in London, and therefore potential as well as existing customers need to access computer systems at all times. Thus, there is no time that is conducive to having a software outage. With the necessity of software applications running 24-hours a day, seven days a week, a problem is created as to how to update or maintain the software of the system. Software development is complicated and can involve millions of lines of code which, inevitably, will need to be updated many times throughout its life span. Modifications are necessary for both bug correction and to offer new functionality. To compound the problem, it is common practice for a software vendor to issue software with known bugs that are to be corrected later. The “first-to-market@strategy has created the practice of distributing Abeta@ versions and 1.0 versions. This strategy does not allow a software vendor to absolutely perfect the software product before going to market. With the existing technology, software must be halted before an upgrade can be made. Thus, businesses have to choose between downtime (that may cost the business customers and profits) and not upgrading software to offer new functionality or correct bugs.

More important than profits are health care concerns. Today's new hospital equipment is mostly computerized and therefore contains software reliant. Presently, hospitals and other health care facilities have to wait for a piece of equipment to be no longer in use before upgrading the residing application. A problem arises, however, when a patient critically needs a piece of equipment at all times and that equipment needs to be upgraded for the benefit of the patient. In this situation, the patient is not able to receive the software since a catch-22 exists as between operating with outdated software or stopping the software for upgrades. Attempts in the past to solve this problem have resulted in maintaining redundant systems that at least double the costs of the systems. While redundant systems are a good practice, they require disconnecting a patient from a piece of equipment, replacing the existing equipment with a new piece of equipment, and performing maintenance on the existing piece of equipment. The ability to update the software without the need to halt the use of the equipment would significantly reduce the number of redundant systems necessary and would allow a back-up piece of equipment to service several online systems.

Also of importance are the computer systems that are used by air traffic controllers and the military. Both of these systems need to run uninterrupted, however, both need periodic upgrades. It would be very beneficial if these systems could be updated without halting the applications.

Previous attempts to provide for the modification of an executing application have not provided a satisfactory remedy. These attempts fall short in at least three key areas. First, they create a second application in memory that wastes valuable computer resources. Second, if the old application takes a long time to complete execution, then there will be two applications in memory wastefully using resources for an unacceptably long time if not indefinitely. Third, system failures during the modification process severely damage the integrity of the computer system.

Accordingly, an object of the present invention is to provide a method for creating a set of computer readable instructions that can be used to safely update a currently executing application without halting the application.

It is another object of this invention to provide a development environment for the development of software that can be modified without halting the application.

### SUMMARY OF THE INVENTION

The above objective is accomplished according to the present invention by providing a system coined a Development Environment (DE). The DE allows a computer programmer to create a file, trademarked as a Hot Pack that can be used to update an executing computer application. A Hot Pack is a computer readable file containing instructions called dictums and object code to be used to modify the executing application. Dictums are rules of steps that are to be followed for modifying a target application, specifically a target grains, from a first version to a second version. Dictums also can contain conditions for when to perform a modification as well as when to execute validity operations to insure data and functional integrity during and after modification. Dictums are more fully described below. A set of computer readable instructions, called a hot swapper, reads the Hot Pack modifies the target application accordingly. The hot swapper is located where the target application is present and can be a stand alone application or integrated with the target application. It is understood that multiple client sites can exist and each can have executing applications that can be modified according to the Hot Pack. For purposes of explaining this invention to those skilled in the art, the following terminology is used.

“Initial Version”—The alpha version of source code, object code, or executable code. This version is created without the existence of any previous versions, and created from scratch.

“First Version”—A version prior to a subsequent version. The first version can also be the initial version, but is not necessarily the initial version. For example, version 2.0 would be a first version to version 3.0. Normally, the first version is being modified to a second version.

“Second Version”—A version subsequent to a first version which is a modification of the first version. The second version would, for example, be version 3.0 from 2.0.

“Source” code is a set of human readable instructions generally written as text file that must be translated by a compiler, interpreter, or assembler into object code.

“Object” code is a set of computer or machine readable instructions produced by a compiler, or interpreter, or assembler that can be executed directly by a computer. Object code can include “executable code” which is a collection of object code that may be linked to libraries in order to produce a finalized program to be executed by a computer.

In development of software, there are two stages. First, the initial version is created by the computer programmer. This version needs to be able to be modified without halting its execution and therefore created with this invention. Second, the initial version may need to be modified and therefore a second version created.

This invention is a computerized software development system and method for generating a hot pack comprising: a computer readable medium and a set of computer readable instructions embodied in the computer readable medium for creating an initial version of source code, storing the initial version of source code within the computer readable medium, segmenting the initial version of source code into initial grains wherein each grain represents segments of source code within the initial version of source code with each of the initial grains having a size less than the total size of the initial version of source code, translating the initial version of source code to an initial version of object code, the object code having object grains corresponding to the initial grains, storing the initial version of the object code within the computer readable medium, retrieving a copy of the initial version of source code from the computer readable medium, storing the copy of the initial version of source code in the computer readable medium as a second version of source code, mapping the grains of the initial version of source code to the grains of the second version of source code, modifying the second version of source code, creating a second version of object code according to the second version of source code, creating dictums representing computer readable instructions for modifying the initial version of object code according to the second version of object code and the grain mapping, and creating a hot pack containing the dictums and the second version of object code so that the initial version of object code can be modified without halting its execution according to the hot pack. Each of the object grain has a size less than the total size of the initial version of object code. The invention includes initial grain boundaries defining the initial grains and the computer readable instructions include instructions for providing the initial grain boundaries to the computer programmer for review so that the computer programmer can review the initial grains and the computer readable instructions include instructions for modifying the initial grain boundaries of the initial version of source code so that the initial grains of the initial version of source code can be modified.

This invention includes computer readable instructions include instructions for verifying lexical information of the second version of source code so that lexical errors may be identified in the second version of source code, for verifying syntactical information of the second version of source code so that syntactical errors may be identified in the second version of source code, for presenting varying compiler optimization levels according to the second version of source code, and receiving an optimization level selection from the programmer for translating the second version of source code into the second version of object code, for storing the selected optimization level within the computer readable medium for subsequent retrieval and a crumb associated with each of the second object grains and having an active state and an inactive state; and, the dictums including computer readable instructions for modifying the initial object code according to the second version of source code and the grain mapping if the crumb associated with the second object grain is in the active state.

### DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a flowchart of the process for creating the initial version of a computer program;

FIG. 2 is a flowchart of creating a Hot Pack;

FIG. 3 is a schematic showing the data flow;

FIG. 4 is a schematic of source code elements; and,

FIG. 5 is a schematic illustrating the various stages of grain modification.

### DESCRIPTION OF A PREFERRED EMBODIMENT

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated. An object or module is a section of computer readable instructions embodied in a computer readable medium that is designed to perform a specific task or tasks. Actual computer or executable code or computer readable code may not be contained within one file or one storage medium but may span several computers or storage mediums. The term Ahost@ and Aserver@ may be hardware, software, or combination of hardware and software that provides the functionality described herein.

The present invention is described below with reference to flowchart illustrations of methods, apparatus (Asystems@) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

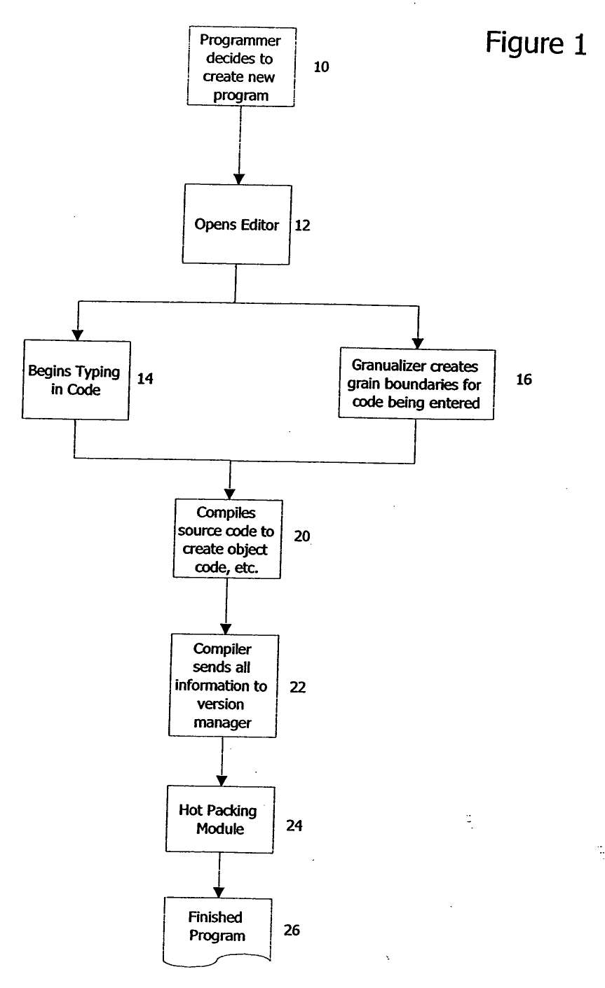

Referring now to FIG. 1, the first step is to create the initial source code for a new program at step 10. The computer programmer begins by opening an editor in step 12 or a set of computer readable instructions for entering or editing source code. The editing module allows for entering the initial version of the source code, modifying the initial version of the source code, and saving the initial version of the source code to a computer readable medium. In step 14, the programmer begins entering the initial version of the source code and contemporaneously in step 16, a granulizing module segments the source code into grains defined by grain boundaries.

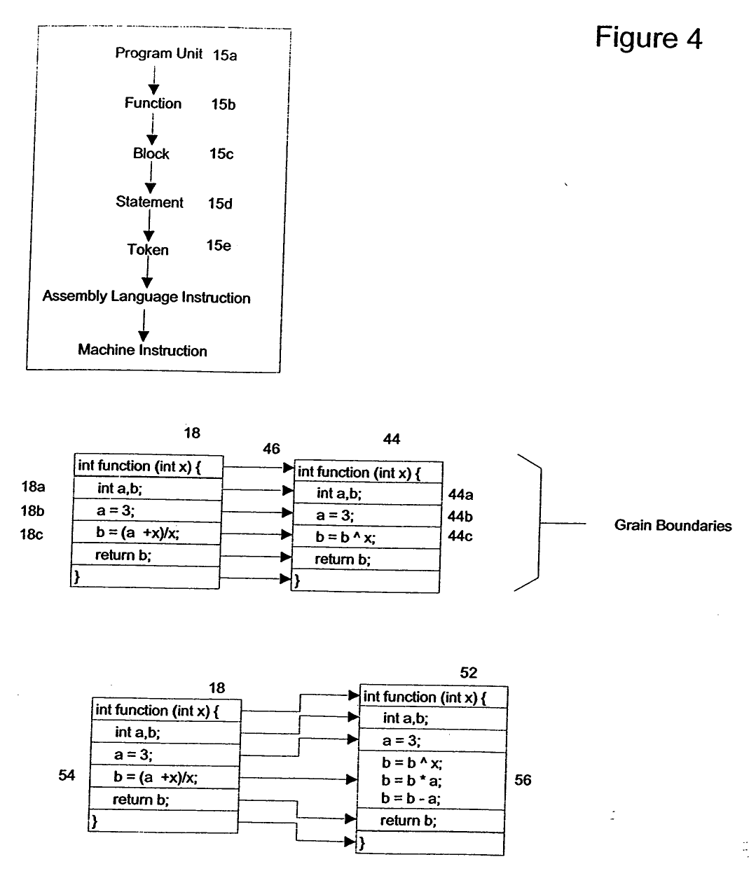

In referring to FIG. 4, grains can be a variety of source code elements 15 ranging from a statement 15d to an entire program unit 15a. A statement 15d is a set of character sequences arranged in a grammatically defined order of a language with some encapsulated meaning. A block 15c is a set of statements encapsulating the functionality of a set of statements. A function 15b is a set of statements and blocks. The main characteristic of a function is that it encapsulates the scope of all the identifier declarations inside it. For example, function 18 shows separate statements such as a=3 and b=(a+x)/x. The grain boundaries can define a grain as the entire function 18 or statements within function 18. Statement 18b, a=3, could be defined as a grain as well. Grains also have a minimum address size when they are created that is maintained in the object code. This minimum size, while partly determined by the implementation of compiler, translator, or assembler, the minimum size is also determined by the object code size of the grain, the crumb, the jump instruction, or all three.

When the computer programmer is adding or editing the source code with the editing module, the granulizing module is defining grains within the source code by adding and managing grain boundaries. For example, when the computer programmer ends the function 18, the granulizing module may place a grain boundary 19a at the beginning of function 18 as well as grain boundary 19b at the end to define function 18 as a single grain. It should be noted that grain boundaries can be modified by the computer programmer, through the granulizing module or the editing module.

Since source code is merely human readable version of object code, both source code and object code fundamentally contain the same functionality. Therefore, the grains of source code segmenting the source code by functionality can be the same logical grains of the object code. While function 18 has grain boundaries 19a and 19b shown surrounding source code, the same logical grain boundary definition would exist in the object code version. Once the computer programmer has completed the initial version of the source code, a compiling module translates the initial version of the source code to an initial version of object code at step 20. When compilation or translation is finished, the compiler sends all the compilation information to a version manager at step 22. The version module stores the initial version of source code in the computer readable medium for later retrieval. Upon translation, the object code is distributed at step 26 for distribution and execution for a customer. At this point, object code has been created and can be distributed that can be modified without halting its execution.

It is understood that the compiling module converts source code to object code. However, it is also possible not just to compile, but also to translate or interpret human readable instructions to machine readable instructions. For purposes of this invention, the term translation is used to mean converting from human readable instructions to machine-readable instructions.

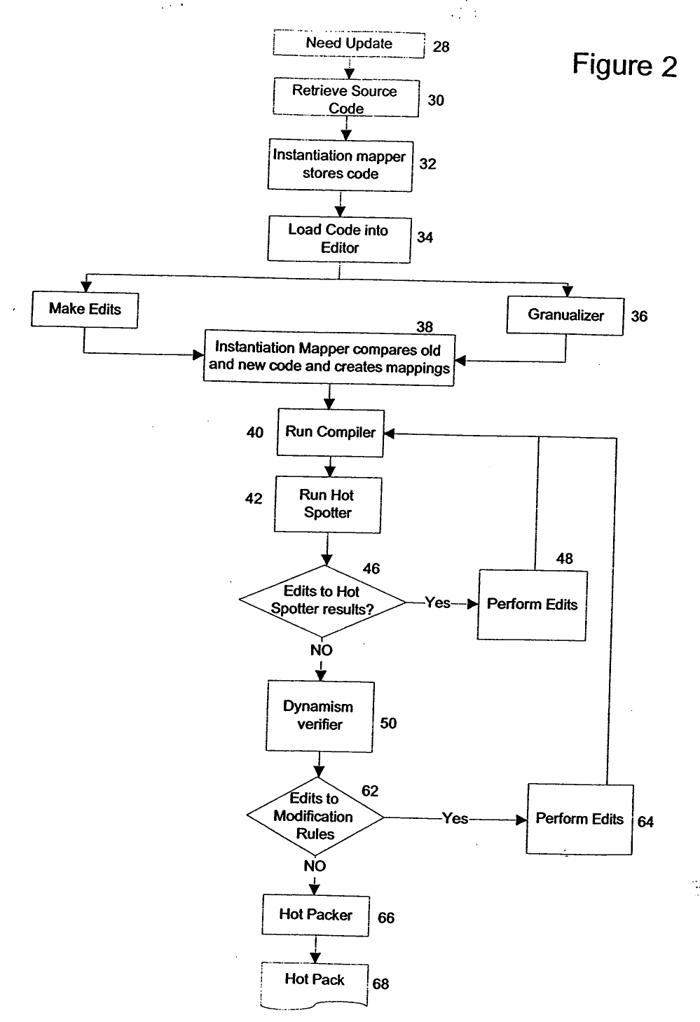

Once the initial object code is distributed and executing at a customer's site, the initial object code may need to be modified. However, it is advantageous to be able to modify the initial version to a subsequent version without halting the executing object code or target. In order to achieve this advantage, a computer programmer begins with the need to update the target application at step 28 of FIG. 2. The programmer wishes to create a Hot Pack in order to update the target. First, the programmer retrieves the source code from the computer readable medium in step 30. In the preferred embodiment, this is done by the instantiation-mapping module for retrieving the source code from the version module and creating a copy of the source code thereby creating a second version of source code at step 32. The second version of source code is then placed in the editing module at step 34. Since the second version of source code is a copy of the first version, the second version also has grains defined by grain boundaries. The computer programmer edits the second version of source code at 35 the granulizing module executes contemporaneously in step 36 and second version of source code into grains according to the grain boundaries. The grain information is provided to the programmer and allows the programmer to modify the grain boundaries and grains. Therefore, if the computer programmer wishes to define a particular segment of the source code into finer grains, the granulizing module allows for the computer programmer to do so. It should be noted that the ability to edit grain boundaries can be performed through the editing module.

When the second version of source code exists, the instantiation mapping module compares the grain boundaries of the first or initial version of source code with the second grain boundaries of the second version of source code and creates a mapping of the first version grains to the second version grains at step 38.

A compiling module in step 40 translates the second version of source code to a second version of object code according to the modification of the second version of source code. It should be noted that the terms first version and second version are not to be used to exclusively reference versions 1.0 and 2.0, but rather to represent an modification between any two versions of source code.

The hot spotting module makes necessary adjustments to the grain mapping so that the first version grains map onto the second version grains. Referring to FIG. 4, function 44 is a modification of function 18. It can be seen that statement 18c (b=a+x)/x) of function 18 has been modified to statement 44c (b=bˆx) of function 44. Grain boundaries 43a corresponds to grain boundary 19a while grain boundary 43b corresponds to grain boundary 19b so that the mapping of function 18 onto function 44 is maintained.

The hot spotter module categorizes the grains into three different categories. The first category contains the new grains that have been created. The second category contains the old grains that have been deleted. The third category contains the modified grains and their corresponding old grains from the first version. The modification of statements 18c to 44c is in this latter category. Using these three categories, the hot spotter can create the mappings of the first grain boundaries to the second grain boundaries necessary for modification. A collection of mappings between first grains and second grains is created and called a dynamic list. The dynamic list is a presented to the computer programmer in step 46. Therefore, the computer programmer can choose whether or not to edit the grain mapping by using the hot spotter interface. If edits are made by the computer programmer to the grain mappings at step 48, the compiler is again executed to regenerate the second version of object code that incorporates the grain boundary edits just made. In an alternate embodiment, the hot spotting module can be executed before the compiling module rather than after.

Next, the dynamism module of step 50 receives the dynamic list and at least a portion of the second version of object code. The dynamism module creates a dictatorial or a second computer readable file that contains at least one dictum or rule for determining the steps to modify the first version of object code to the second version of object code. The dictatorial contains dictums for replacing the first grains with the second grains. For example, a first function 18 of FIG. 4 having grain boundaries 17a-17g, is modified to function 52 having grain boundaries 53a-53g. Practically, the modification involves the replacement of statement 54 with a block of statements 56. Therefore, the dictatorial would contain the grain boundaries 17d and 17e of function 18, the grain boundaries 53d and 53e of function 52, and the instructions and dictums to replace grain 54 with grain 56. It is understood that the functionality of the dynamism module can be performed either prior to subsequent to the translation of the source code to object code. In the embodiment when the dynamism module functions prior the translation of the compiler, the hot pack is generated upon execution of the dynamism module after the compiler so that the hot pack will contain the dictums and the object code for updating the target application.

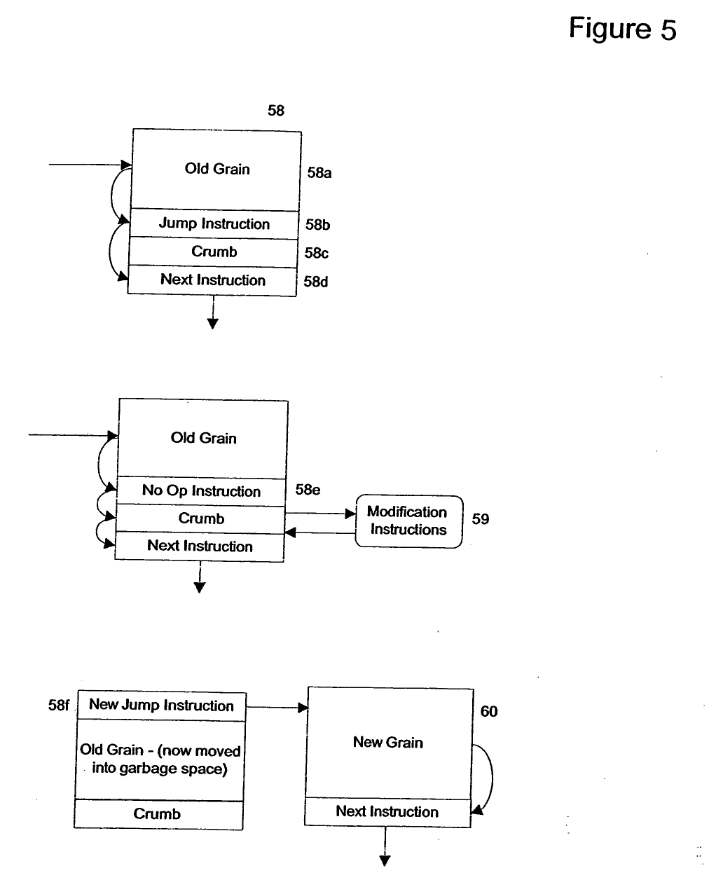

Once a grain is identified as needing modification, there are two methods for modifying the grain. These two methods can be used separately or in conjunction with each other. Therefore, first is the instantaneous phase. In this phase, dictums that can be executed instantly are executed. These dictums are executed and the associated second grains replace the corresponding first grain upon execution of the hot pack. Under this phase, there was no inconsistency preventing immediate modification of the first grain to the second grain. Second is the incremental phrase. The incremental phase allows for a dictum to be executed subsequent to the initial application of the hot pack since there is some reason not to execute the particular dictum immediately. For example, the instruction pointer may be in that grain or the grain may be in recursion. Thus, the grain must be modified at a subsequent period. When a grain is defined by the computer programmer or granulizer, the compiler translates the grain into computer readable instructions represented as 58 of FIG. 5. Adjacent to a grain can be a jump instruction 58b and crumb 58c. Crumbs can be placed before or after a grain and can be created by the compiler or can be added by the hot swapper during modification.

Next instruction 58d executes after first grain 58a. Normally, the first grain, jump instruction and next instruction executes as shown by arrow 57. Jump instruction 58b prevents crumb 58c from executing. However, when the first grain is to be modified into the second grain, the computer readable instructions located at the target includes instructions that convert jump instruction 58b into a no-op instruction 58e. The no-op instructions causes crumb 58c to execute and thereby causes modification instructions 59 to also execute. These modification instructions result in new jump instruction 58f being placed in front of the first grain to point to second grain 60. Second grain 60 then executes a next instruction command executes. Although not illustrated, second grain 60 can also contain a crumb for subsequent modification. The first grain and associated crumb are moved into garbage space and no longer part of the executing object of the target. Therefore, the second grain 60 replaces old grain 58 and the object code is updated to a second version.

In an alternative embodiment, a second (new) grain can replace a first (old) grain by use of an indirection table. An indirection table is a small address table within the computer readable medium that contains a list of memory addresses corresponding to the various grains. For example, the first grain would start at address 0x1000h and be X bytes long while the next grain may start at 0x2000h and be Y bytes long. An offset pointer points to the address within the indirection table to show where the grains are located. Whenever a call is made to the first grain, the compiler generates computer readable code so that the address where the first grain is located retrieved from the indirection table and the target executes the instructions at the first grains address. The second grain may be present at another address such as 0x3000h and Z bytes long. Therefore, to modify a first grain to a second grain, the indirection table is updated so that the indirection table contains the starting address of the second grain rather that the first. Therefore, the object code of the executing application goes to address 0x3000h rather than 0x1000h by way of example and the second grain execute instead of the first grain.

An additional embodiment includes the utilization of both the crumb as well as the indirection table. In this embodiment, crumbs can be associated the addresses within the indirection table and these crumbs, and their associated jump instructions, can be integrated into the indirection table for the address entries and modification of the indirection table can be may through the crumb process.

Referring to FIG. 2, in step 62, the computer programmer is given the opportunity to modify the dictums through the dynamism module in the event that it is desired to change the dictatorial. If there are changes to the dictorial, the computer programmer performs the changes in step 64 and the compiler regenerates the second version of object code. Next, hot packer receives the dictatorial and at least a portion of the second version of object code at step 66 and generates a Hot Pack at step 68. The Hot Pack can then be sent to the customer and executed so that the first version of object code is modified into the second version of object code without halting the execution of the first version.

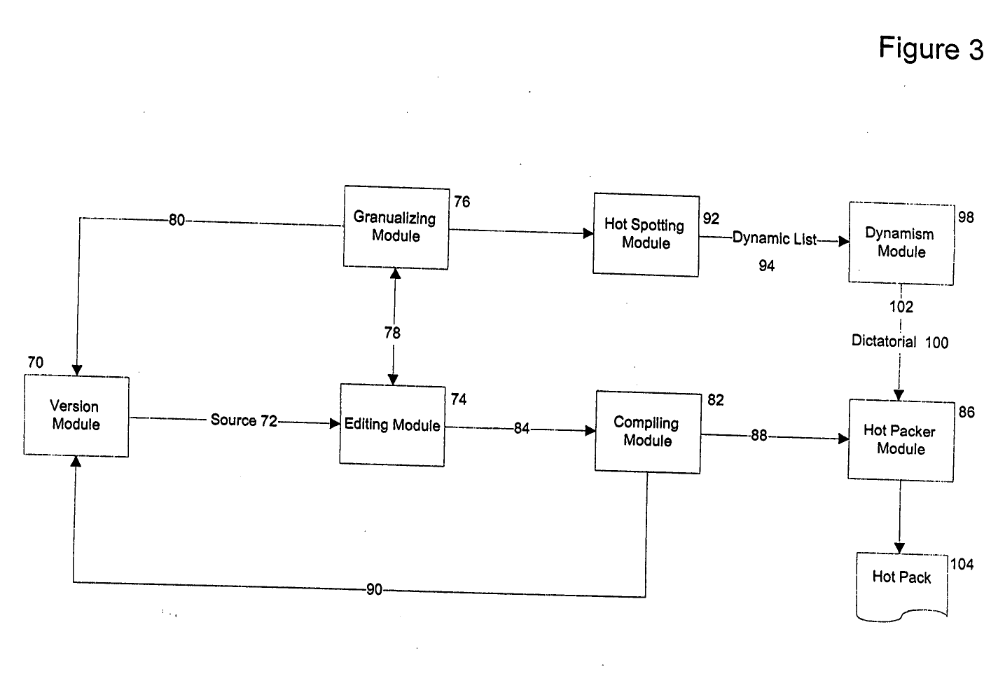

Referring now to FIG. 3, the data flow between the various modules or among the computer readable instructions is explained. The source code is stored in version module 70 at the beginning of the creation process. The source code then travels along data path 72 to editing module 74, instantaneous mapping module 71 and also through data path 81. The instantaneous mapping module duplicates the first version of source code second version of source code and provides the second version of source code to the computer programmer through editing module 74. While changes are made to the source code, granulizing module 76, by data path 78 is aware of the edits being made. Therefore, granulizing module 76 automatically generates grain boundaries within the source code thereby defining grains. These grain boundaries are provided to the instantaneous mapping module 71 along data path 80. The instantaneous mapping module then transmits the grain boundary information to the version module through path 81 and to editing module through path 83 while maintaining the mapping between the first version and the second version grains. Once the edits to the source code are complete, compiling module 82 receives the source code through data path 84. A dynamism analyzer 106 also receives information from dynamism module 98 along data path 108 and allows for edits to the dictums. Compiling module 82 creates object code according to the source code. The object code is transmitted to hot packing module 86 via data path 88. Compiling module 82 also transmits the object code to version module 70 via data path 90 and information to dynamism module 98 through data path 105. Hot spotting module 92 receives grain information from granulizing module 76 and generates a dynamic list 94 that is transmitted along data path 96 to dynamism module 98. The hot spotting module also provides information along data path 108 to the editing module. The dynamism module then creates a dictatorial 100 that is transmitted along data path 102 to hot packing module 86 to create a hot pack 104. The hot pack is then transmitted to the customer and used to modify a first version of executable code to a second version of executable code without halting the first version executing code.

While a preferred embodiment of the invention has been described using specific terms, such description is for illustrative purposes only, and it is to be understood that changes and variations may be made without departing from the spirit or scope of the following claims.

What is claimed is:

1. A computerized software development system for generating a hot pack comprising:
a computer readable medium; and,
a set of computer readable instructions embodied in said computer readable medium for creating an initial version of source code, storing said initial version of source code within said computer readable medium, segmenting said initial version of source code into initial grains wherein each grain represents segments of source code within said initial version of source code with each of said initial grains having a size less than the total size of said initial version of source code, translating said initial version of source code to an initial version of object code, said object code having object grains corresponding to said initial grains, storing said initial version of said object code within said computer readable medium, retrieving a copy of said initial version of source code from said computer readable medium, storing said copy of said initial version of source code in said computer readable medium as a second version of source code, mapping said grains of said initial version of source code to said grains of said second version of source code, modifying said second version of source code, creating a second version of object code according to said second version of source code, creating dictums representing computer readable instructions for modifying said initial version of object code according to said second version of object code and said grain mapping, and creating a hot pack containing said dictums and said second version of object code so that said initial version of object code can be modified without halting its execution according to said hot pack.

2. The system of claim 1 wherein said each of said object grains having a size less than the total size of said initial version of object code

3. The system of claim 1 including:
initial grain boundaries defining said initial grains; and,
said computer readable instructions include instructions for providing said initial grain boundaries to the computer programmer for review so that the computer programmer can review said initial grains.

4. The system of claim 3 wherein said computer readable instructions include instructions for modifying said initial grain boundaries of said initial version of source code so that said initial grains of the initial version of source code can be modified.

5. The system of claim 1 wherein said computer readable instructions include instructions for verifying lexical information of said second version of source code so that lexical errors may be identified in said second version of source code.

6. The system of claim 1 wherein said computer readable instructions include instructions for verifying syntactical information of said second version of source code so that syntactical errors may be identified in said second version of source code.

7. The system of claim 1 wherein said computer readable instructions include instructions for presenting varying compiler optimization levels according to said second version of source code, and receiving an optimization level selection from the programmer for translating said second version of source code into said second version of object code.

8. The system of claim 7 wherein said computer readable instructions include instructions for storing said selected optimization level within said computer readable medium for subsequent retrieval.

9. The system of claim 1 including:
a crumb associated with each of said second object grains and having an active state and an inactive state; and,
said dictums including computer readable instructions for modifying said initial object code according to said second version of source code and said grain mapping if said crumb associated with said second object grain is in said active state.

10. A computerized software development system for modifying a first version of object code having first grain boundaries and first grains to a second version of object code comprising:
a computer readable medium;
a set of computer readable instructions embodied in said computer readable medium for retrieving said first version of source code from said computer readable medium, copying said first version of source code into a second version of source code, creating second grain boundaries associated with said second version of source code for defining second grains, mapping said first grains to said second grains, modifying said second version of source code, translating said second version of source code to a second version of object code while maintaining said mapping of said first and second grains, creating a dynamic list of first grains and corresponding second grains for the said second grains containing modified source code, creating at least one dictum according to said dynamic list and at least a portion of said second version of object code representing computer readable instructions for modifying said first version of object code to said second version of object code, and generating a hot pack according to said dictum and at least a portion of said second version of object code so that said hot pack can be distributed in order to modify said first version of object code to said second version of object code without halting the execution of said first version of object code.

11. The system of claim 10 wherein said computer readable instructions include instructions for modifying said second grain boundaries once said second grain boundaries have been created.

12. The system of claim 10 wherein said computer readable instructions include instructions for verifying lexical information of said second version of source code so that lexical errors may be identified in said second version of source code.

13. The system of claim 10 wherein said computer readable instructions include instructions for verifying syntactical information of said second version of source code so that syntactical errors may be identified in said second version of source code.

14. The system of claim 10 wherein said computer readable instructions include instructions for providing varying compiler optimization levels according to said second grain boundaries, and receiving an optimization level selection from the programmer for translating said second version of source code into said second version of object code.

15. The system of claim 14 wherein said computer readable instructions include instructions for storing said selected optimization level in said computer readable medium.

16. The system of claim 10 wherein said computer readable instructions include instructions for adding a dictum to said computer readable instructions.

17. The system of claim 10 wherein said computer readable instructions include instructions for modifying said dynamic list after said dynamic list has been created.

18. A method for providing an initial version of object code according to an initial version of source code where the initial version of object code can be modified without halting its execution comprising the steps of:
creating an initial version of source code;
segmenting said initial version of source code into initial grains having initial grain boundaries within said initial version of source code;
translating said initial version of source code to an initial version of object code;
copying said initial version of source code to a second version of source code having second grain boundaries and second grains;
mapping said second grains to said initial grains;
modifying said second version of source code;
creating a second version of object code according to said second version of source code; and,
creating instructions for modifying said initial object code according to said second version of object code and said grain mapping.

19. The method of claim 18 including the step of creating a hot pack containing said instructions for modifying said initial object code and said second version of object code so that said initial object code can be modified without halting its execution according to said hot pack.

20. The method of claim 18 including the step of verifying the lexical information of said second version of source code so that lexical errors may be identified in said second version of source code.

21. The method of claim 18 including the step of verifying syntactical information of said second version of source code so that syntactical errors may be identified in said second version of source code.
